(19) United States
(12) Patent Application Publication
(10) Pub. No.: US 2025/0096307 A1
(43) Pub. Date: Mar. 20, 2025

(54) NOVEL ELECTROLYTE FOR LITHIUM-ION BATTERIES

(71) Applicant: GM Global Technology Operations LLC, Detroit, MI (US)

(72) Inventors: Dewen Kong, Shanghai (CN); Yan Wu, Shanghai (CN); Haijing Liu, Shanghai (CN); Mark W. Verbrugge, Sonoma, CA (US)

(21) Appl. No.: 18/499,309

(22) Filed: Nov. 1, 2023

(30) Foreign Application Priority Data
Sep. 18, 2023 (CN) 202311203864.9

(51) Int. Cl. H01M 10/0569; H01M 4/02; H01M 4/38; H01M 4/583; H01M 10/0525

(52) U.S. Cl. CPC H01M 10/056

(57) ABSTRACT

In an embodiment, an electrolyte includes a lithium salt and a cosolvent, where the cosolvent comprises a cyclic carbonate-containing solvent and a linear carbonate-containing solvent. In an embodiment, a battery includes an anode, a cathode, an electrolyte and a separator. The anode includes an anode current collector and an anode active layer. The anode active layer comprises a lithiated silicon oxide or a combination of lithiated silicon oxide and carbon present in an amount of 20 wt % or greater, based on a total weight of the anode active layer. The cathode includes a cathode current collector and a cathode active layer. The electrolyte includes a lithium salt and a cosolvent that includes a cyclic carbonate-containing solvent and a linear carbonate-containing solvent.

### CROSS-REFERENCE TO RELATED APPLICATIONS

This application claims priority to Chinese Patent Application No. 202311203864.9, filed Sep. 18, 2023, and all the benefits accruing therefrom under 35 U.S.C. § 119, the contents of which in its entirety are herein incorporated by reference.

### INTRODUCTION

The subject disclosure relates to novel electrolytes for lithium-ion batteries and to methods of manufacture of such batteries.

High energy density electrochemical cells, such as lithium-ion batteries, can be used in a variety of consumer products and vehicles, such as batteries or hybrid electric vehicles. As battery power and service life continue to advance, battery powered vehicles appear to be promising as a transportation option.

Lithiated silicon oxide (LSO) have demonstrated the ability to provide lithium-ion batteries with a high energy density and fast recharging capabilities when used in the anode active layer. Lithium-ion batteries (that use lithiated silicon oxide (LSO)) in the anode active layer often contain electrolytes that contain linear carbonate solvents such as, for example, ethylene carbonate and dimethyl carbonate. The lithium-ion batteries that contain lithium silicon oxide as the anode active material and electrolytes that contain linear carbonate solvents are often manufactured to be in the form of a pouch cell.

Pouch cells are often manufactured via a hot lamination process conducted at temperatures of 65 to 85° C. The hot lamination process however, causes swelling of the solvents and evaporation of the dimethyl carbonate, which results in poor cyclability for the lithium-ion battery. It is therefore desirable to use electrolytes that can better withstand the lithium battery manufacturing process.

### SUMMARY

In an embodiment, an electrolyte includes a lithium salt and a cosolvent, where the cosolvent comprises a cyclic carbonate-containing solvent and a linear carbonate-containing solvent.

In another embodiment, the lithium salt comprises a primary lithium salt and a secondary lithium salt.

In yet another embodiment, the primary lithium salt is LiPF₆.

In yet another embodiment, the secondary lithium salt is one or more of lithium bis(trifluoro-methanesulfonyl)imide (LiTFSI), lithium bis(fluorosulfonyl)imide (LiFSI), lithium bis(oxalato)borate (LiBOB), lithium (difluoromethanesulfonyl) (trifluoromethanesulfonyl)imide (LiDFTFSI), lithium difluorooxalatoborate (LIODFB), or a combination thereof.

In yet another embodiment, the lithium salt is LiPF₆.

In yet another embodiment, the cyclic carbonate-containing solvent comprises a 5-membered cyclic ring with a carbonate moiety, that has a boiling point greater than 200° C. and a melting point less than 50° C.

In yet another embodiment, the cyclic carbonate-containing solvent has a boiling point greater than 225° C. and a melting point less than −25° C.

In yet another embodiment, the cyclic carbonate-containing solvent has a structure of formula (1):

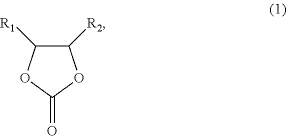

where R₁ and R₂ can be the same or different and are independently a hydrogen, a C₁ to C₅ alkyl or a halogen.

In yet another embodiment, R₁ is hydrogen, R₂ is a hydrogen, a C₁-C₃ alkyl or a fluorine.

In yet another embodiment, the cyclic carbonate-containing solvent is ethylene carbonate (EC), propylene carbonate (PC), 1,2-butylene carbonate, 2, 3-butylene carbonate, fluoroethylene carbonate (FEC), or a combination thereof.

In yet another embodiment, the cyclic carbonate-containing solvent is propylene carbonate (PC), fluoroethylene carbonate (FEC), or a combination thereof.

In yet another embodiment, cyclic carbonate-containing solvent is present in an amount of 5 to 87 wt %, based on a total weight of the electrolyte.

In yet another embodiment, the linear carbonate-containing solvent is ethyl methyl carbonate, dimethyl carbonate, diethyl carbonate, ethyl butyrate, methyl butyrate, or a combination thereof.

In yet another embodiment, the linear carbonate-containing solvent is ethyl methyl carbonate, dimethyl carbonate, or a combination thereof.

In an embodiment, a battery includes an anode, a cathode, an electrolyte and a separator. The anode includes an anode current collector and an anode active layer. The anode active layer comprises a lithiated silicon oxide or a combination of lithiated silicon oxide and carbon. The lithiated silicon oxide or the combination of lithiated silicon oxide and carbon are present in an amount of 20 wt % or greater, based on a total weight of the anode active layer. The cathode includes a cathode current collector and a cathode active layer. The separator is disposed between the anode and the cathode. The electrolyte includes a lithium salt and a cosolvent, where the cosolvent comprises a cyclic carbonate-containing solvent and a linear carbonate-containing solvent.

In yet another embodiment, the lithiated silicon oxide has the formula Li_{y}SiOₓ and where the combination of lithiated silicon oxide and carbon has the formula Li_{y}SiOₓ—C; where y is 0 to 1 and x is 0 to 2.

In yet another embodiment, the cyclic carbonate-containing solvent comprises a 5-membered cyclic ring with a carbonate moiety, that has a boiling point greater than 200° C. and a melting point less than 50° C.

In yet another embodiment, the cyclic carbonate-containing solvent has a boiling point greater than 225° C. and a melting point less than −25° C.

In yet another embodiment, the linear carbonate-containing solvent is ethyl methyl carbonate (EMC), dimethyl carbonate (DMC), diethyl carbonate (DEC), ethyl butyrate (EB), methyl butyrate (MB), or a combination thereof.

In an embodiment, a method of manufacturing a lithium-ion battery includes stacking together an anode, a cathode and a separator. The separator is disposed between anode and cathode. The anode and cathode are contacted with an anode terminal and a cathode terminal respectively. The anode and the cathode are placed in a pouch. The pouch with the anode, cathode and separator disposed therein at a temperature of 60 to 85° C. to form a laminate. An electrolyte is disposed in the pouch to form the lithium-ion battery. The anode comprises an anode active layer that comprises a lithiated silicon oxide or a combination of lithiated silicon oxide and carbon in an amount of 20 wt % or greater, based on a total weight of the anode active layer. The electrolyte includes a lithium salt and a cosolvent. The cosolvent includes a cyclic carbonate-containing solvent and a linear carbonate-containing solvent.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a cross-section of a lithium-ion pouch cell;

FIG. 2 is a graph that depicts voltage (V) versus capacity ((Ah)-Ampere-hours) at a capacity rate of 1 coulomb (C) at 25° C.;

FIG. 3 is a graph that shows state of charge (SOC) in percentage versus charge time (in minutes) taken to reach a particular amount of charge;

FIG. 4A is a graph that depicts discharge capacity retention (in percentage) versus cycle number; and

FIG. 4B is a graph that depicts Voltage (V) versus capacity (ampere-hours).

### DETAILED DESCRIPTION

The following description is merely exemplary in nature and is not intended to limit the present disclosure, its application or uses.

In accordance with an exemplary embodiment, disclosed herein is an electrolyte for use in lithium-ion batteries that comprises a cyclic carbonate-containing solvent in addition to a linear carbonate-containing solvent. This combination of compatible cyclic and linear carbonate-containing solvents (hereinafter “cosolvent”) has a boiling point greater than 100° C. and a melting point less than −10° C. (minus 10° C.), which provides the electrolyte with thermal stability at elevated temperatures that are used in the pouch cell lamination process. The low melting point enhances cell low temperature performance. Compared with electrolytes that contain one or more linear carbonate-containing solvents, the disclosed cosolvent-containing electrolyte suppresses the swelling of pouch cells that contain anodes that have over 40% lithium silicon oxide during hot lamination pouch cell manufacturing processes that are conducted at temperatures of 80° C. Pouch cells that contain the electrolyte (that contains the cosolvent) displays outstanding fast charge capability (these cells can charge upto 85% of the total state of charge (SOC) within 20 minutes), enhanced DC fast charge (DCFC) cycle life and low temperature discharge capacity (−20° C./25° C. 1C capacity retention of greater than or equal to about 55%). The term “1C capacity” refers to 1 coulomb (C) discharge capability at −20° C. (minus 20° C.). Cells were charged at C/3 to 4.2V using a constant current constant voltage (CCCV) charging protocol with a C/20 taper at 25° C., then soaked cell at −20° C. (minus 20° C.) for 6 hours and discharged at 1C to a voltage of 2.5V.

Disclosed herein too are lithium-ion batteries that contain the aforementioned electrolyte. This electrolyte is useful in pouch cell lithium-ion batteries that contain lithiated silicon oxide in the anode active layer. The anode active layer preferably contains the lithiated silicon oxide in an amount of greater than 20 wt %, based on a total weight of the anode active layer. The term “lithiated” implies that a material (e.g., a silicon oxide) is combined or impregnated with lithium or a lithium compound. The use of the aforementioned electrolyte (with the cosolvent) permits high temperature lamination of the battery because the higher boiling point of the carbonate-containing cyclic solvent prevents the evaporation of the solvent and the swelling of the battery.

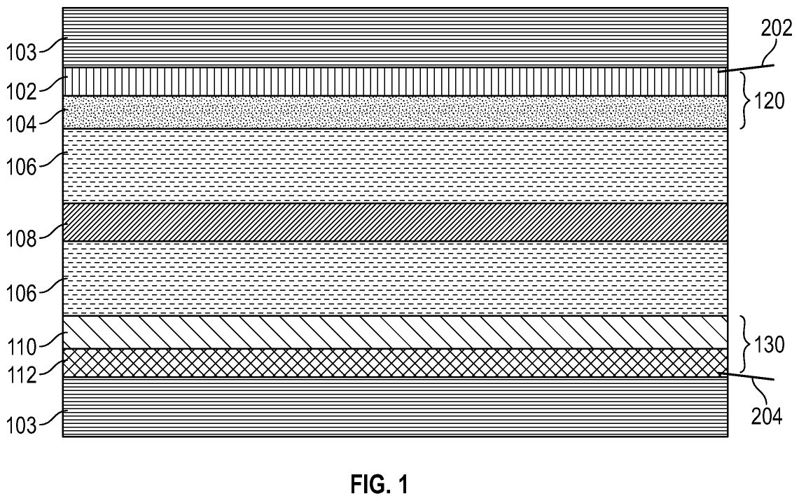

FIG. 1 details a lithium-ion pouch cell 100. The anode 120 used in the pouch cell 100 includes an anode current collector 102 and an anode active layer 104. The cathode 130 used in the pouch cell includes a cathode current collector 112 and a cathode active layer 110. A separator 108 separates the anode 120 from the cathode 130. An electrolyte 106 is disposed in the pouch cell 100 between the anode active layer 104 and the separator 108 and is also disposed in the pouch cell 100 between the cathode active layer 110 and the separator 108. The anode 120, the cathode 130, the separator 108 and the electrolyte 106 are enclosed in a pouch 103.

The anode current collector 102 and the cathode current collector 112 comprise a metal. Examples of suitable metals used in the anode current collector 102 include stainless steel, copper, nickel, iron, titanium, or a combination thereof. Examples of suitable metals used in the cathode current collector 112 include stainless steel, aluminum, nickel, iron, titanium, or a combination thereof.

The electrolyte comprises a cosolvent (a cyclic carbonate-containing solvent and a linear carbonate-containing solvent), a lithium salt and additives. The cyclic carbonate-containing solvent is preferably a 5-membered cyclic ring with a carbonate moiety. It preferably has a boiling point greater than 200° C., preferably greater than 225° C. with a melting point less than 50° C., preferably less than 0° C. and more preferably less than −25° C. (minus 25° C.). In an embodiment, the cyclic carbonate-containing solvent has the structure of formula (1) below.

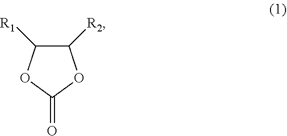

where R₁ and R₂ can be the same or different and are independently a hydrogen, a C₁ to C₅ alkyl or a halogen. In an embodiment, R₁ is hydrogen, while R₂ is a hydrogen, a C₁-C₃ alkyl or a fluorine. Preferred cyclic carbonates are ethylene carbonate (EC), propylene carbonate (PC), 1,2-butylene carbonate, 2, 3-butylene carbonate, fluoroethylene carbonate (FEC), or a combination thereof. In a preferred embodiment, the cyclic carbonate used in the electrolyte is propylene carbonate, fluoroethylene carbonate, or a combination thereof.

In an embodiment, the electrolyte may contain one or more cyclic carbonate-containing solvents. If only one cyclic carbonate solvent is used, then the solvent is preferably propylene carbonate. If two or more cyclic carbonate solvents are used, then the solvents are preferably propylene carbonate and fluoroethylene carbonate.

The cyclic carbonate-containing solvent may be present in the electrolyte in an amount of 5 to 75 volume percent (vol %), preferably 10 to 50 and more preferably 20 to 40 vol %, based on a total volume of the electrolyte. If for example, a halogenated cyclic carbonate-containing solvent (e.g., fluoroethylene carbonate) is used in conjunction with another cyclic carbonate-containing solvent in the electrolyte, then the halogenated cyclic carbonate-containing solvent is present in the electrolyte in an amount of 3 to 25 vol %, preferably 5 to 10 vol %, based on a total volume of the electrolyte.

The electrolyte preferably contains linear carbonate solvents that have a boiling point of greater than 100° C. and a melting point that is preferably less than 0° C., preferably less than −25° C. and more preferably less than −50° C. The linear carbonate solvent used in the electrolyte has the structure of formula (2) below.

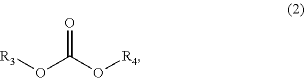

where R₃ and R₄ can be the same or different and are independently a C₁ to C₆ alkyl or a halogen. In an embodiment, R₃ is a C₁ alkyl or a C₂ alkyl while R₄ is also a C₁ or C₂ alkyl. In another, embodiment, R₃ is a C₁ alkyl or a C₂ alkyl while R₄ is a C₂ alkyl. Examples of linear carbonate solvents include ethyl methyl carbonate (EMC), diethyl carbonate (DEC), ethyl butyrate (EB), methyl butyrate (MB), or a combination thereof.

In another embodiment, the linear carbonate solvent can have the structure of formula (3)

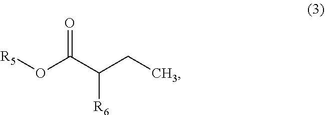

where R₅ and R₆ are the same or different and are each independently a hydrogen or a C₁ to C₅ alkyl. In a preferred embodiment, R₅ is a C₁-C₂ alkyl while R₆ is hydrogen. Examples of solvents of formula (3) are methyl butyrate, ethyl butyrate, methyl 2-methylbutyrate, or a combination thereof.

If only one linear carbonate solvent is used, then the solvent is preferably one of ethyl methyl carbonate or diethyl carbonate. If two or more linear carbonate solvents are used, then the solvents are preferably ethyl methyl carbonate and diethyl carbonate. In an embodiment, the ethyl methyl carbonate and diethyl carbonate are added to the electrolyte in a volume ratio (ethyl methyl carbonate to diethyl carbonate) of 3/5 to 3/9, preferably 3/6 to 3/8.

The linear carbonate-containing solvent may be present in the electrolyte in an amount of 5 to 87 volume percent (vol %), preferably 10 to 50 vol %, and more preferably 20 to 40 vol %, based on a total volume of the electrolyte.

In an embodiment, the combined amount of the cyclic and linear carbonate-containing solvent is present in the electrolyte in an amount of 10 to 50 vol %, preferably 20 to 40 vol %, based on a total volume of the electrolyte used in the pouch cell.

The electrolyte used in the lithium-ion battery comprises a lithium salt in addition to the cosolvent. It is desirable for the lithium salt to completely dissolve and dissociate in the electrolyte and the solvated lithium-ions (Li⁺) should have high mobility for ion transportation. The anion should be stable against oxidative decomposition at the cathode and reductive decomposition at the anode. Examples of lithium salts include lithium hexafluorophosphate (LiPF₆), lithium perchlorate (LiClO₄), lithium hexafluoroarsenate (LiAsF₆), lithium tetrafluoroborate (LiBF₄), lithium bis(trifluoro-methanesulfonyl)imide (LiTFSI), lithium bis(fluorosulfonyl)imide (LiFSI), lithium bis(oxalato)borate (LiBOB), lithium (difluoromethanesulfonyl)(trifluoromethanesulfonyl)imide (LiDFTFSI), lithium difluorooxalatoborate (LIODFB), lithium difluorophosphate (LiPO₂F₂), lithium iodide (LiI), lithium bromide (LiBr), lithium chloride (LiCl), lithium thiocyanate (LiSCN), lithium nitrate (LiNO₃), lithium nitrite (LiNO₂), lithium sulfate (Li₂SO₄), or a combination thereof. A preferred lithium salt is lithium hexafluorophosphate (LiPF₆). The lithium salt is added to the electrolyte in a molar amount of 0.6 to 2.0 M, preferably 0.8M to 1.2 M.

In an embodiment, the electrolyte may contain a primary lithium salt and a secondary lithium salt. A preferred primary lithium salt is lithium hexafluorophosphate (LiPF₆), while secondary lithium salts are one or more of lithium bis(trifluoro-methanesulfonyl)imide (LiTFSI), lithium bis(fluorosulfonyl)imide (LiFSI), lithium bis(oxalato)borate (LiBOB), lithium (difluoromethanesulfonyl)(trifluoromethanesulfonyl)imide (LiDFTFSI), lithium difluorooxalatoborate (LIODFB), or the like, or a combination thereof.

The lithium salts are present in the electrolyte in an amount of 7 to 20 weight percent (wt %), preferably 9 to 13 wt %, based on a total weight of the electrolyte. The lithium salts may be diluted with water prior to being introduced into the lithium-ion battery. For example, the lithium salt may be added to the pouch cells in concentrations of up to 2.0M (molar), preferably 0.8M to 1.2M.

Additives can optionally be added to the electrolyte. The additives can include other solvents, phosphites and/or phosphates, sulfates, or a combination thereof, to improve cell performance. Examples of additive solvents include vinylene carbonate, 1,3-propane sultone, or a combination thereof. Additive phosphites can include tris(trimethylsilyl) phosphite (TMSPi) while additive phosphates can include tris(trimethylsilyl) phosphate (TTSP). Sulfate esters of 1,3,2-dioxathiolane 2,2-dioxide (DTD) and/or trimethylene sulfate (TMS) may also be added to the electrolyte. These additives may be used individually or in any combination. Each of the additives may optionally be added in amounts of 0.1 to 10 wt %, preferably 0.5 to 3 wt %, based on a total weight of the electrolyte.

The anode active layer 104 is disposed on the anode current collector 102. The cathode active layer 110 is disposed on the cathode current collector 112. The anode active layer generally comprises an anode active material that is disposed on the current collector and subjected to drying to form the anode active layer. The cathode active layer generally comprises a cathode active material that is disposed on the current collector and subjected to drying to form the cathode active layer. The anode active material generally comprises an electrically conductive material and a polymeric binder in addition to the anode active material. The cathode active material generally comprises an electrically conductive material and a polymeric binder in addition to the cathode active material. A solvent may sometimes be used to create a slurry, which is then disposed on the anode current collector or the cathode current collector and subjected to drying.

Anode active materials include some of the aforementioned carbonaceous materials, hard carbon, silicon, silicon mixed with graphite, silicon oxide mixed with graphite, carbon encapsulated silicon particles, Li₄Ti₅O₁₂; transition metals such as, for example, tin, metal oxides, metal sulfides, (e.g., TiO₂, FeS, and the like) lithium metal and alloys, or a combination thereof. Exemplary active materials may include graphite, hard carbon, activated carbon, nanoform carbon, silicon, silicon oxides, silicon oxide mixed with graphite, carbon encapsulated silicon nanoparticles, or a combination thereof. In some such embodiments, the anode active material may be intercalated with lithium (e.g., using pre-lithiation methods known in the art).

Hard carbon is a solid form of carbon that cannot be converted to graphite by heat-treatment, even at temperatures as high as 3000° C. It is also known as char, or non-graphitizing carbon. Hard carbon is produced by heating carbonaceous precursors to approximately 1000° C. in the absence of oxygen. Among the precursors for hard carbon are polyvinylidene chloride (PVDC), lignin and sucrose. Other precursors, such as polyvinyl chloride (PVC) and petroleum coke, produce soft carbon, or graphitizing carbon. Soft carbon can be readily converted to graphite by heating to 3000° C.

In an embodiment, silicon and/or silicon oxide mixed with graphite can be used as the anode active material. Silicon monoxide and its suboxides (SiOₓ) are promising anode materials for lithium-ion batteries which provide high specific capacity and improved cycling performance, with some similarities to Si anodes. While Li oxide (Li2O) and Li silicates (Li₄SiO₄), generated by the reaction of Li ion with SiOx during the first lithiation process lowers the theoretical capacity, they also act as buffer components to accommodate volume changes caused by further reactions between Si in SiOx with Li, leading to improved cyclability. In an embodiment, it is desirable to use lithiated silicon oxide (LSOs) having the formula Li_{y}SiOₓ and Li_{y}SiOₓ—C, where y is 0 to 1 and x is 0 to 2. The LSO's may be in the form of nanotubes, nanofibers, nanoplatelets, nanoparticles or microparticles.

In a preferred embodiment, the anode active material comprises silicon oxide mixed with graphite. The silicon oxide may be lithiated prior to or after mixing with the graphite. The anode active material may be used in the anode active layer respectively in an amount of greater than 20 wt %, preferably 30 to 60 wt %, based on a total weight of the anode active layer.

The electrically conducting material, the polymeric binder and the solvent is used in both the anode active layer and the cathode active layer. All three ingredients—the electrically conducting material, the polymeric binder and the solvent are first detailed below. Various electrically conducting materials that may be used in either the anode active layer or the cathode active layer are detailed below.

The electrically conducting additive preferably comprises an electrically conducting carbonaceous material. Examples of electrically conducting carbonaceous materials include carbon nanotubes, carbon black, activated carbon, graphene, graphite, graphite oxide, carbon fibers, or the like, or a combination thereof. It is desirable for the electrically conducting composition to form an electrically conducting network that extends from a surface of the current collector to the surface of the electrode (that contacts the electrolyte).

Carbon nanotubes include single wall carbon nanotubes (SWNTs), double wall carbon nanotubes (DWNTs), multiwall carbon nanotubes (MWNTs), or a combination thereof and have diameters of 2 to 100 nanometers, preferably 10 to 50 nanometers. They have lengths of 20 to 10,000 nanometers, preferably 200 to 5000 nanometers. Aspect ratios greater than 10, preferably greater than 50 and more preferably greater than 100 are desirable.

Carbon black having a high surface area is preferred for use in the electrode. Carbon black (subtypes are acetylene black, channel black, furnace black, lamp black and thermal black) is a material produced by the incomplete combustion of coal and coal tar, vegetable matter, or petroleum products, including fuel oil, fluid catalytic cracking tar, and ethylene cracking in a limited supply of air. Carbon black is a form of paracrystalline carbon that has a high surface-area-to-volume ratio, albeit lower than that of activated carbon. Carbon black having a surface area of 50 to 1000 m²/gm may be used in the slurry that is used to form the electrode. Examples of carbon black that can be used in the electrode-forming slurry are KELTJEN™ Black or Super P.

Graphene is an allotrope of carbon consisting of a single layer of atoms arranged in a hexagonal lattice nanostructure. Graphene that is added to the slurry may be in the form of individual graphene sheets or in the form of a plurality of loosely connected graphene sheets. Each atom in a graphene sheet is connected to its three nearest neighbors by σ-bonds and a delocalized π-bond, which contributes to a valence band that extends over the whole sheet. This is the same type of bonding seen in carbon nanotubes and polycyclic aromatic hydrocarbons, and in fullerenes and glassy carbon. The valence band is touched by a conduction band, making graphene a semimetal with unusual electronic properties that are best described by theories for massless relativistic particles.

In an embodiment, the graphene can be in the form of graphene nanoplatelets (GNP). Exfoliated graphite nano-platelets comprise nanoparticles that contain graphite. These nanoparticles consist of small stacks of graphene that are 1 to 15 nanometers thick, with diameters ranging from sub-micrometer to 100 micrometers.

Graphite particles may also be used in the electrically conducting composition. Graphite is a natural manifestation of pure carbon with a hexagonal crystal structure that is arranged in several parallel levels, called graphene layers. In short, graphite particles comprise a plurality of graphene sheets that are arranged to be parallel to each other. This anisotropic structure gives the graphite special properties, such as electrical conductivity or a particular strength along the individual layers. It is extremely heat-resistant with a sublimation point of over 3,800° C., thermally highly conductive and chemically inert.

Graphite oxide (GO), sometimes called graphene oxide, graphitic oxide or graphitic acid, is a compound of carbon, oxygen, and hydrogen in variable ratios, obtained by treating graphite with strong oxidizers and acids for resolving of extra metals. The maximally oxidized bulk product is a yellow solid with a C:O ratio between 2.1:1 and 2.9:1, that retains the layer structure of graphite but with a much larger and irregular spacing. The bulk material spontaneously disperses in basic solutions or can be dispersed by sonication in polar solvents to yield monomolecular sheets, known as graphene oxide by analogy to graphene, the single-layer form of graphite. Graphene oxide sheets exist in the form of strong paper-like materials, membranes, thin films, and composite materials and can be used in the electrode-forming slurry that is used to prepare the electrodes.

Carbon fibers have diameters of 5 to 10 micrometers and are composed mostly of carbon atoms. They can have lengths greater than 1000 micrometers, preferably greater than 10,000 micrometers. The are produced by drawing pitch or polyacrylonitrile polymeric fibers under high pressures and temperatures of over 1500° C., preferably at temperatures greater than 2200° C. Carbon fibers are different from carbon nanotubes and do not have cylindrical graphene sheets arranged concentrically. The carbon fibers typically comprise high aspect ratio graphene sheets arranged to be in a parallel configuration with each other.

The aforementioned carbon nanotubes, carbon black, activated carbon, graphene sheets, graphite particles, graphite oxide particles, or a combination thereof may be used individually or in any combination to form an electrically conducting network. In an exemplary embodiment, the carbon nanotubes typically are used in the largest amount when compared with the other carbonaceous ingredients.

The active layer may contain the electrically conducting additive in an amount of up to 10 wt %, preferably 0.5 to 3 wt %, based on a total weight of the active layer.

The electrode-forming slurry also optionally comprises a polymeric binder. The polymeric binder binds the electrically conducting additive and the active material so that they remain in contact with the current collector and do not get dispersed in the electrolyte during the manufacturing process or during use. The polymeric binder preferably does not reduce electrical conductivity of the active layer disposed on the current collector. The active layer comprises the electrically conducting additive and the respective anode or cathode active material.

The polymeric binder for respective electrodes (the anode 120 or the cathode 130) is preferably a fluorine containing homopolymer or copolymer. In a preferred embodiment, the binder is a fluorine containing copolymer. In an embodiment, the fluorine containing copolymer is at least one of poly(vinylidene fluoride-co-chlorotrifluoroethylene) (abbreviated as P(VDF-CTFE)), poly(vinylidene fluoride-trifluoroethylene) (abbreviated as P(VDF-TeFE)), poly(vinylidene fluoride-trifluoroethylene-chlorofluoroethylene) terpolymer (abbreviated as P(VDF-TrFE-CFE)), poly(vinylidene fluoride-hexafluoropropylene) (abbreviated as P(VDF-HFP) or PVDF-HFP), or a combination thereof. In a preferred embodiment, the polymeric binder used in the active layer is poly(vinylidene fluoride-hexafluoropropylene) copolymer. In another embodiment, the binder can include carboxymethyl cellulose (CMC) combined with styrene butadiene rubber (SBR) or carboxymethyl cellulose combined with styrene butadiene rubber and polyacrylic acid (PAA). The polymeric binder has a weight average molecular weight of 5,000 to 1,000,000 grams per mole, preferably 50,000 to 750,000 grams per mole, and more preferably 75,000 to 500,000 grams per mole measured using gel permeation chromatography with a polystyrene standard.

In an embodiment, the polyvinylidene content of any of the aforementioned binders is 80 to 95 wt %, based on a total weight of the polymeric binder. The remaining polymer content of the copolymer is 5 to 20 wt %, based on the total weight of the polymeric binder. For example, if the polymeric binder is a poly(vinylidene fluoride-hexafluoropropylene) copolymer, then the polyvinylidene content of the copolymer is 80 to 95 wt %, based on a total weight of the polymeric binder, while the poly hexafluoropropylene content of the copolymer is 5 to 20 wt %, based on a total weight of the copolymer.

The total weight of the polymeric binder in the active layer after the solvent is removed is less than 10 wt %, preferably less than 8 wt %, and more preferably less than 6 wt %, and more preferably less than 5 wt % of a total weight of the active layer. The polymeric binder if present, is present in an amount of greater than 0.1 wt % of the total weight of the active layer. A lower weight of the polymeric binder in the active layer facilitates a lower reduction in the electrically conducting capabilities of the active layer. In other words, the lower the amount of the polymeric binder, the greater the electrical conducting capacity of the active layer will be. The active layer is disposed on the current collector and comprises the pertinent (anode or cathode) active material, the electrically conducting additive and the polymeric binder.

Lithium (Li)- and manganese-rich (LMR) layered-structure materials may be used as cathode active materials. Lithium-manganese-rich (LMR) layered oxides, also known as over-lithiated oxides (OLO), are of interest as cathode materials for lithium-ion batteries given their high capacities (greater than 250 mAh/g) and energy densities. An example of an LMR is provided in Equation (1) below:

(p)Li₂MnO₃(1−p)LiR₁O₂ (1),

where R₁ is Mn, Ni or Co and p is greater than zero and less than 1.

Another example of an LMR is provided in Equation (2) below:

Li_{(2-x-y)}RₓM_{y}O₂ (2), where

R is Ni and M is at least one of Mn, Ni, Co, or Al, where x+y<1 and where x is greater than 0.1 and less than 0.5.

An example of a LMR is Li [Li_{1/3}Mn_{2/3}]O₂ (generally designated as Li₂MnO₃) and LiR₁O₂ (where R₁ is nickel) with a specific capacity of approximately 250 mAh/g. Other LMR's that may be used in the cathode active layer include lithium manganese oxide (LMO with variant formulas of LiMn₂O₄, Li₂MnO₃ and others), LiNbO₃-coated LiMn₂O₄ and Al-doped LiMn₂O₄.

Examples of other LMR's include lithium cobalt oxide (LCO, sometimes called “lithium cobaltate” or “lithium cobaltite”—one variant of which is LiCoO₂); lithium nickel manganese cobalt oxide (NMC, with a variant formula of LiNiMnCo); lithium nickel cobalt aluminum oxide (LiNiCoAlO₂ and variants thereof as NCA) and lithium titanate oxide (LTO, with one variant formula being Li₄Ti₅O₁₂); lithium iron phosphate oxide (LFP, with one variant formula being LiFePO₄), lithium nickel cobalt aluminum oxide (and variants thereof as NCA) as well as other similar other materials, spinel (LiMn₂O₄, LiNi_{0.5}Mn_{1.5}O₄), polyanion cathode (LiV₂ (PO₄)₃), and other lithium transition-metal oxides. Low voltage cathode materials (e.g., lithiated metal oxide/sulfide (e.g., LiTiS₂), lithium sulfide and sulfur) may also be used.

Other variants of the foregoing may be included. In some embodiments where NMC is used as an active material, nickel rich NMC may be used. For example, in some embodiments, the variant of NMC may be LiNiₓMn_{y}Co_{(1-x-y)} O₂, LiNiₓ Mn_{y}Al_{(1-x-y)} O₂, LiNiₓMn₍₁₋ₓ₎ O₂, Li₁₊ₓMO₂, or a combination thereof, where x is equal to or greater than about 0.7, 0.75, 0.80, 0.85, or more and where y is less than 0.15, preferably less than 0.1. In some embodiments, NMC811 may be used, where in the foregoing formula x is about 0.8 and y is about 0.1.

In yet another embodiment, the lithium and manganese-rich layered-structure material is Li_{z}NiₓMn_{y}Co_{(1-x-y)} O₂, LiNiₓMn_{y}Al_{(1-x-y)} O₂, LiNiₓMn₍₁₋ₓ₎ O₂, or a combination thereof, where y is equal to or greater than about 0.5 and where x is less than 0.4 and where z is equal to or greater than 1.0 and is less than 1.5.

The cathode active material may be used in the cathode active layer respectively in an amount of 70 to 99 wt %, preferably 92 to 96 wt %, based on a total weight of the cathode active layer.

The electrode-forming slurry can be manufactured in several different ways. In one embodiment, in one method of manufacturing the respective electrodes (the anode or the cathode), the electrically conducting composition, the polymeric binder, the anode or the cathode active materials and the cosolvent (such as those listed above) can be mixed in a single mixing device such as a blender for an appropriate amount of time to form the slurry. The time of mixing can be 30 minutes to 5 hours. The slurry with the appropriate active material is then disposed on the respective current collector to form the anode or cathode. The slurry after being disposed on the current collector is subjected to drying to form the active layer.

The drying may be conducted at a temperature of 100 to 170° C. for a period of 30 minutes to 10 hours, preferably 1 to 5 hours. The mixing is conducted in a planetary mixer, although other blenders such as Waring blenders, Henschel mixers, single and multiple screw extruders may also be used.

The electrolyte containing the cosolvent the anode comprising the LSO may be used in a lithium-ion battery that is used in the form of a pouch cell, a winding cell or a cylindrical cell. In a preferred embodiment, the lithium battery containing the aforementioned ingredients is in the form of a pouch cell.

A pouch cell 100 (see FIG. 1) is a soft battery design where most of the cell components are enclosed in an aluminum-coated plastic film. Only two terminals 202 and 204 protrude from the pouch. Each of the terminals are welded to one of the current collectors 102 and 112 respectively in the pouch 103. These highly conductive tabs are in electrical communication with the anode 120 and cathode 130 and allow to get the electric energy out of the pouch cell 100.

Inside the pouch 103, the cell components are arranged in repeated stacks of multiple layers. Each stack contains three layers of solid sheets, two layers of active material and a layer of a liquid electrolyte. The three layers of solid sheets include an anode current collector, a cathode current collector and a separator. The two layers of active material include an anode active material that contacts the anode current collector (to form the anode 120) and a cathode active material that contacts the cathode current collector (to form the cathode 130). The layer of liquid electrolyte 106 includes the cosolvent (e.g., a combination of cyclic and linear carbonate-containing solvents) and a lithium salt. When the battery charges or discharges, the ions travel between the cathode and the anode through the liquid electrolyte.

With reference now again to the FIG. 1, pouch cells 100 are often manufactured by a hot lamination process. In the hot lamination process, the ingredients used for manufacturing the electrodes such as the binding agent, the solvent, the respective active material (the cathode active material or the anode active material) and the conductive material are first mixed together to form a homogeneous paste. These ingredients are mixed under vacuum to prevent air bubbles from getting whipped into the paste as well as moisture from contaminating the anode active material and electrolyte. When the paste is homogeneous, it is moved to a machine called the coater where it is poured onto a sheet of a highly conductive metal foil (the “current collector” in the final assembly). This coater machine then scrapes off excess paste and dries the remaining paste.

Once dried, the semi-shaped electrode is placed into a rolling press to be compressed at high pressure to achieve the right porosity and thickness for the final electrode sheet. The higher the porosity, the better the electron flow, which increases the cells' performance. At this point, the sheet can be cut into the desired shape and size, leaving a conductive tip at the top to contact the tab.

With the electrode sheets prepared, the pouch cell 100 is assembled in a controlled environment to prevent moisture from damaging the lithium-ion battery cell components. The first step in the assembly includes welding a metal strip to the current collector. This strip will later be used to fix the terminals 202 and 204. It is traditionally welded using ultrasonic bonding, but laser welding is gaining in popularity.

Using a stacking machine, the separator 108 is placed between the electrodes, forming a stack that is inserted in the pouch. The stack is then laminated at a temperature of 60 to 85° C. in a roll mill. The sides of the pouch 103 are joined together with a method called heat sealing, leaving one side open. An electrolyte filling system is then used to add the liquid electrolyte 106 into the cell.

Then, the pouch 103 is sealed using a vacuum sealing machine, and the pouch cell 100 assembly is complete. The pouch 103 will protect and hold together the components.

The pouch cell along with the ingredients disclosed herein will now be described in the following non-limiting examples.

### EXAMPLES

### Example 1

This example was conducted to demonstrate the use and properties of the cell in a hot lamination process. The hot lamination process was conducted as detailed above. The pouch cell contained a LSO anode in an amount of greater than 40 wt %, based on a total weight of the active layer. Additional details of the pouch cell are provided below.

The cathode active layer contains nickel cobalt magnesium aluminum (NCMA) having an areal capacity of 5 milliampere hours per square centimeter (mAh/cm²). The mass ratio of ingredients used the cathode active layer are as follows: nickel cobalt magnesium aluminum NCMA/Super P carbon black (SP)/single wall carbon nanotubes (SWCNT)/polyvinylidene fluoride (PVDF)=95/2.9/0.1/2. The density of the cathode active layer is 3.3 g/cm³.

The cathode used in the pouch cell is a double sided cathode having two layers of the cathode active material disposed on opposing sides of the cathode current collector (one layer per each side of the cathode current layer). The cathode current collector comprises aluminum metal of thickness 15 micrometers with two cathode active layers—each of 75 micrometers thickness disposed on opposing sides of the aluminum metal (one on each side of the aluminum current collector). The total cathode thickness is about 165 micrometers.

The anode active layer contains 37.56 wt % of lithiated silicon oxide (LSO) and has an areal capacity of 5.5 mAh/cm². The mass ratio of the ingredients in the cathode active layer are as follows: LSO/Graphite/SP/SWCNT/carboxymethyl cellulose (CMC)/styrene butadiene rubber (SBR)/polyacrylic acid (PAA)=37.56/56.34/0.5/0.1/1.5/2.0/2.0. The anode active layer density is 1.45 g/cm³.

The anode used in the pouch cell is a double sided anode having two layers of the anode active material disposed on opposing sides of the anode current collector (one layer per each side of the anode current layer). The anode current collector comprises copper metal of thickness 6 micrometers with two anode active layers—each of 53 micrometers thickness disposed on opposing sides of the copper metal (one on each side of the copper current collector). The total anode thickness is about 112 micrometers.

The electrolyte used in the pouch cell is a lithium salt (1M LiPF₆), solvent (propylene carbonate and ethyl methyl carbonate in a volume ratio of 3 to 7, fluoroethylene carbonate in an amount of 5 wt % and vinylene carbonate in an amount of 1 wt %) and additives (1 wt % of TMSPi, 1 wt % of LiBOB, 1 wt % of DTD).

In manufacturing the pouch cell, the anode, the cathode and the electrolyte were stacked and that included calendaring, punching, stacking, wielding, pre-sealing, drying, electrolyte filling, formation, degassing, final sealing, and sorting steps to make stacked bilayer pouch cells in a dry room with a dew point of −45° C. (minus 45° C.). The pouch cell has a capacity of 3.7 ampere-hours (Ah), the voltage range is 2.5-4.2V. The hot laminating is conducted at 70° C. for 1 hour followed by 80° C. for 0.67 hours. The use of a cyclic-carbonate-containing solvent reduces pouch cell manufacturing time from 46.2 hours to 2.9 hours.

No solvent expansion occurred (during the manufacturing process) from using the cosolvent that contained the cyclic carbonate-containing solvent in addition to the linear carbonate-containing solvent in the electrolyte. The pouch cell therefore displays a tolerance for high temperatures used during manufacturing as well as high temperatures that may be encountered during use.

### Example 2

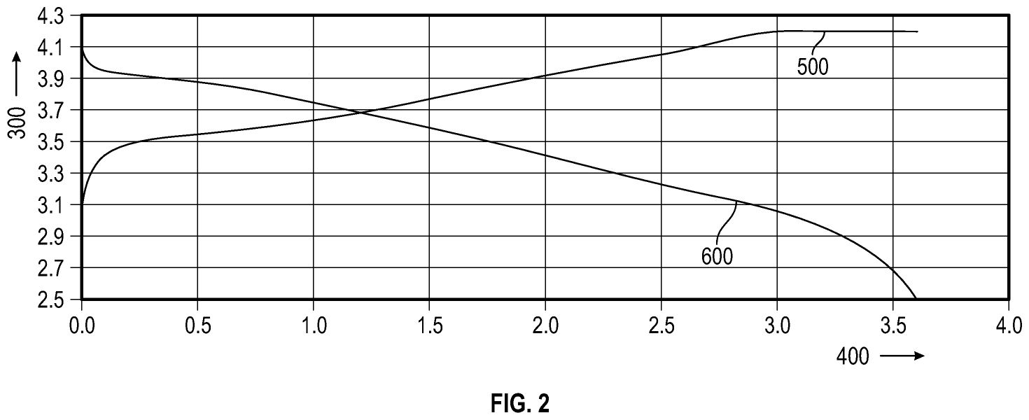

This example was conducted to determine the pouch cell capacity. The pouch cell used was that detailed in Example 1. FIG. 2 is a graph that depicts voltage (V) (300) versus capacity ((Ah)-Ampere-hours) (400) at a capacity rate of 1C at 25° C. The pouch cell was charged/discharged within a voltage range of 2.7-4.2V (vs Li⁺/Li). The pouch cell was charged to 4.2V at a current rate of 1C (see charge curve (500), held until C/20, and then discharged to 2.7V at a constant current rate of 1C (see discharge curve 600).

Some of the characteristics of the pouch cell are detailed in the Table 1 below.

TABLE 1

| Discharge | Average | 1 C discharge GED | 1 C discharge VED |
|---|---|---|---|
| Capacity | Discharge | (Watt-hours/ | (Watt hours/liter @ |
| (Ampere hours) | Voltage (V) | kilogram) | 100% SOC) |
| 3.57 | 3.43 | 297.21 | 691.80 |

### Example 3

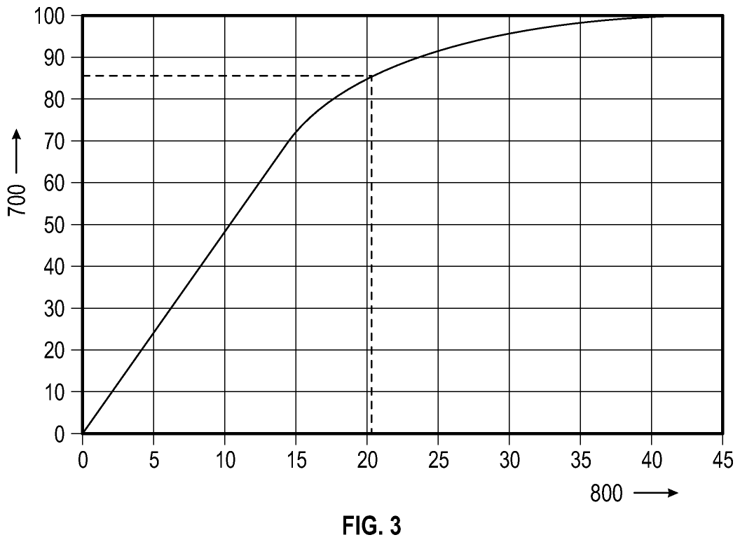

This example is conducted to determine charge rate. For the charge rate test, the pouch cell was charged at 3C-rates at 3C till 4.2V with a C/20 taper at 25° C. FIG. 3 is another graph that shows state of charge (SOC) in percentage (700) versus charge time (in minutes) (800) taken to reach a particular amount of charge. From the FIG. 3 it may be seen that 85% of SOC was achieved in 20 minutes with no application of external pressure. This example shows that the disclosed pouch cell demonstrates outstanding capacity for charging.

### Example 4

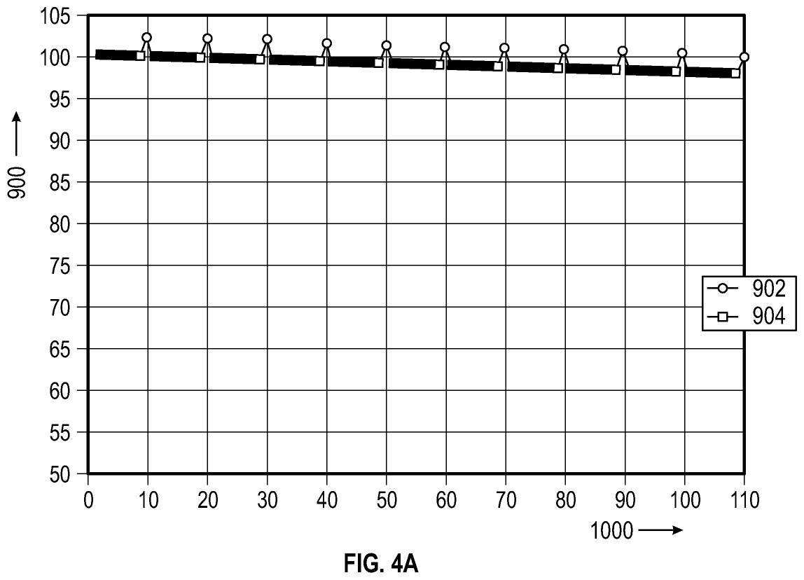

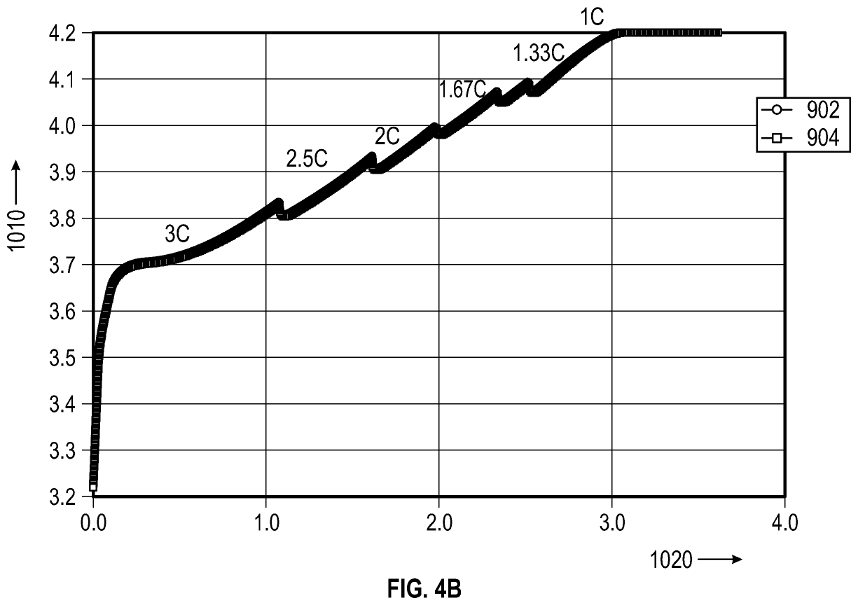

This example was conducted to determine direct current fast charging (DCFC) cycle performance. No faceplate pressure was used in these DCFC tests. Two identical pouch cells 902 and 904 were charged/discharged within a voltage range of 2.0-4.2V (vs Li+/Li). The pouch cells were each charged to 4.2V at a current rate of 2C, held until C/20, and then discharged to 2.5V at a constant current rate of 1C. FIGS. 4A and 4B are graphs that depict the performance of the two pouch cells during the DCFC tests. FIG. 4A is a graph that depicts discharge capacity retention (in percentage) (900) versus cycle number (1000) while FIG. 4B depicts Voltage (V) (1010) versus capacity (ampere-hours) (1020). From these results it may be seen that both cells using the cyclic carbonate-containing electrolyte demonstrated good DCFC cycle performance.

From the aforementioned examples, it may be seen that compared with traditional linear carbonate-containing solvent (e.g., ethyl carbonate and dimethyl carbonate) based electrolytes, cyclic carbonate-containing based electrolytes suppress the swelling of pouch cells (having 30 to 40 wt % lithiated silicon oxide) during the 80° C. hot laminating formation process and demonstrate an outstanding fast charge capability (achieving 85 percent of SOC within 20 minutes) in addition to displaying enhanced DCFC cycle life and low temperature discharge capacity (−20° C. to 25° C. 1C capacity retention greater than 55%).

The terms “a” and “an” do not denote a limitation of quantity, but rather denote the presence of at least one of the referenced item. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electrolyte comprising:
a lithium salt; and
a cosolvent; where the cosolvent comprises a cyclic carbonate-containing solvent and a linear carbonate-containing solvent.

2. The electrolyte of claim 1, wherein the lithium salt comprises a primary lithium salt and a secondary lithium salt.

3. The electrolyte of claim 2, where the primary lithium salt is LiPF₆.

4. The electrolyte of claim 2, where the secondary lithium salt is one or more of lithium bis(trifluoro-methanesulfonyl)imide (LiTFSI), lithium bis(fluorosulfonyl)imide (LiFSI), lithium bis(oxalato)borate (LiBOB), lithium (difluoromethanesulfonyl) (trifluoromethanesulfonyl)imide (LiDFTFSI), lithium difluorooxalatoborate (LIODFB), or a combination thereof.

5. The electrolyte of claim 1, where the lithium salt is LiPF₆.

6. The electrolyte of claim 1, where the cyclic carbonate-containing solvent comprises a 5-membered cyclic ring with a carbonate moiety, that has a boiling point greater than 200° C. and a melting point less than 50° C.

7. The electrolyte of claim 6, where the cyclic carbonate-containing solvent has a boiling point greater than 225° C. and a melting point less than −25° C.

8. The electrolyte of claim 1, where the cyclic carbonate-containing solvent has a structure of formula (1): 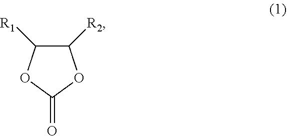
where R₁ and R₂ can be the same or different and are independently a hydrogen, a C₁ to C₅ alkyl or a halogen.

9. The electrolyte of claim 8, where R₁ is hydrogen, R₂ is a hydrogen, a C₁-C₃ alkyl or a fluorine.

10. The electrolyte of claim 1, where the cyclic carbonate-containing solvent is ethylene carbonate (EC), propylene carbonate (PC), 1,2-butylene carbonate, 2, 3-butylene carbonate, fluoroethylene carbonate (FEC), or a combination thereof.

11. The electrolyte of claim 1, where the cyclic carbonate-containing solvent is propylene carbonate (PC), fluoroethylene carbonate (FEC), or a combination thereof.

12. The electrolyte of claim 1, the cyclic carbonate-containing solvent is present in an amount of 5 to 87 wt %, based on a total weight of the electrolyte.

13. The electrolyte of claim 1, where the linear carbonate-containing solvent is ethyl methyl carbonate, dimethyl carbonate, diethyl carbonate, ethyl butyrate, methyl butyrate, or a combination thereof.

14. The electrolyte of claim 13, where the linear carbonate-containing solvent is ethyl methyl carbonate, dimethyl carbonate, or a combination thereof.

15. A battery comprising:
an anode; where the anode comprises an anode current collector and an anode active layer; where the anode active layer comprises a lithiated silicon oxide or a combination of lithiated silicon oxide and carbon; where the lithiated silicon oxide or the combination of lithiated silicon oxide and carbon are present in an amount of 20 wt % or greater, based on a total weight of the anode active layer.
a cathode; where the cathode comprises a cathode current collector and a cathode active layer;
a separator disposed between the anode and the cathode; and
an electrolyte; where the electrolyte comprises a lithium salt and a cosolvent; where the cosolvent comprises a cyclic carbonate-containing solvent and a linear carbonate-containing solvent.

16. The battery of claim 15, where the lithiated silicon oxide has the formula Li_{y}SiOₓ and where the combination of lithiated silicon oxide and carbon has the formula Li_{y}SiOₓ—C; where y is 0 to 1 and x is 0 to 2.

17. The battery of claim 15, where the cyclic carbonate-containing solvent comprises a 5-membered cyclic ring with a carbonate moiety, that has a boiling point greater than 200° C. and a melting point less than 50° C.

18. The battery of claim 15, where the cyclic carbonate-containing solvent has a boiling point greater than 225° C. and a melting point less than −25° C.

19. The battery of claim 15, where the linear carbonate-containing solvent is ethyl methyl carbonate (EMC), dimethyl carbonate (DMC), diethyl carbonate (DEC), ethyl butyrate (EB), methyl butyrate (MB), or a combination thereof.

20. A method of manufacturing a lithium-ion battery comprising:
stacking together an anode, a cathode and a separator; where the separator is disposed between anode and cathode; where the anode comprises an anode active layer that comprises a lithiated silicon oxide or a combination of lithiated silicon oxide and carbon in an amount of 20 wt % or greater, based on a total weight of the anode active layer;
contacting the anode and cathode with an anode terminal and a cathode terminal respectively;
placing the anode and the cathode in a pouch;
laminating the pouch with the anode, cathode and separator disposed therein at a temperature of 60 to 85° C. to form a laminate; and
disposing an electrolyte in the pouch to form the lithium-ion battery; where the electrolyte comprises lithium salt and a cosolvent; where the cosolvent comprises a cyclic carbonate-containing solvent and a linear carbonate-containing solvent.
